(19) United States
(12) Patent Application Publication
(10) Pub. No.: US 2017/0208022 A1
(43) Pub. Date: Jul. 20, 2017

(54) CHAT SYSTEM

(71) Applicant: SIMPLE MATTERS LIMITED, Berkshire (GB)

(72) Inventor: Jonathan Peter Vincent DRAZIN, Berkshire (GB)

(21) Appl. No.: 15/328,377

(22) PCT Filed: Jul. 10, 2015
(86) PCT No.: PCT/GB15/51999

§ 371 Date: Jan. 23, 2017

(30) Foreign Application Priority Data
Jul. 22, 2014 (GB) 1412996.9

(51) Int. Cl. H04L 12/58; G06F 7/08; G06F 17/30; G06F 3/0482

(52) U.S. Cl. CPC H04L 51/046; G06F 3/0482; G06F 7/08; G06F 17/30675

(57) ABSTRACT

A communication device for enabling a conversation with at least one other device, the conversation relating to an item; the communication device being adapted to: present a plurality of user selectable questions relating to the item; receive a signal indicative of user selection of one of the user selectable questions and send the selected question to the at least one other device as part of the conversation exchange.

### FIELD OF THE INVENTION

The invention relates to an improved system for interactive message communication and involves the fields of computer data and database processing, computer communications, mobile and tablet device input from and display to users, and other methods of electronic communications.

### BACKGROUND OF THE INVENTION

Interactive message systems, sometimes referred to as chat systems, have been in use for several years and many such as Facebook Messenger, Kik, Skype and WhatsApp are adapted to mobile phone use. A common problem with chat systems and related mobile device applications is that their operation is separated from systems and applications that display content, such as information about items for retail, about which their users may converse. A result is that third parties that present such content cannot easily quantify for research purposes the relative frequencies of questions raised about their items, or measure the magnitudes of sentiments expressed in relation to them.

On smart phones and tablets today, members of a conversation must navigate between sources of item related content and the communication systems that connect them for discussion within the conversation. This is time-consuming because they must navigate out of one application and navigate into another. Further, they frequently need to cut portions of content from the item content display, such as URLs and paste them into the conversation. This process can be repetitive and inconvenient to members. Due to their size, mobile phones have small keyboards making questions and answers difficult to compose. Further, on deciding what question to ask about an item of content, the questions may not be known. When presented with a question, the range of possible answers to the question about the item may not be known so that asked members either answer inappropriately or do not answer at all.

Conventional mobile chat systems typically display an arrangement of posts, each containing a message, along a screen dimension representing the time order in which messages are sent (a “timeline”). Such methods do not arrange the messages in a compact form suited to comprehension or later access through on-screen navigation. Chat conversations between members of a group typically include pluralities of messages distributed over time about pluralities of items and subjects. Members seeking to interpret the conversation in relation to particular items face problems because messages are cluttered with other messages relating to other items and subjects.

Conventional chat systems display details of an item while members participate in a conversation. Typically, these systems allow members to cut and paste content (such as an HTML page, a photograph or voice message) or a link into the content timeline. The pasted content or link is available to a member to view in his/her own time. A drawback with this approach is that it is difficult for a member of a conversation to discuss a particular item of content, because the other members may not be viewing the same content referred to by the member. Indeed, other members may mistake references made by the member to the wrong item. For example a member posts two photos, each of a different pair of shoes, and then posts a text message. Using conventional chat display methods it is unclear to the other members which pair if any the member meant the message to refer to. Yet another limitation of conventional systems is that they do not allow members to talk with each other in real time in order to facilitate introduction, following and discussion of item content.

### SUMMARY OF THE INVENTION

According the present invention, there is provided a communication device that is adapted to enable a conversation with at least one other device; determine that the conversation relates to an item of content such as a description of a product and/or a service (hereafter referred to collectively as a “item”); present a user one or a plurality of user selectable questions relating to the item; receive a signal indicative of user selection of one of the user selectable questions and send the selected question to the at least one other device.

The device may be adapted to store the user selectable questions for presenting to the user in response to a user request. The device may be adapted to present a user selectable cell that when selected causes the user selectable questions to be presented to the user.

The device may be adapted to present one or a plurality of user selectable answers to questions relating to an item; receive a signal indicative of user selection of one of the user selectable answers and send the selected answer to the at least one other device.

The other device may be adapted to present one or a plurality of user selectable answers to user selectable questions received from the device during the conversation.

In response to the indicative signal, the device may send a request to a remote device, such as an application server, for information to generate the user selectable questions and/or answers. On receipt of the information, the device may be adapted to store the information for later use to present the user selectable questions and/or answers to the user. Alternatively, the device may be adapted to use the information to present the user selectable questions to the user.

The device may be adapted to present the user selectable questions or user selectable answers in a random order or an order determined by a remote system.

The device may be adapted to send to the remote system a message indicative of the user selectable questions or answers actually selected during a conversation exchange. Based on the user selections, the remote system may determine an order in which to present the user selectable questions or answers. The remote system may count the user selections of each user selectable question or user selectable answer over a time period. The remote system may rank the options according to their respective counts. The remote system may send the rankings to the plurality of devices. In response, the plurality of devices are adapted to display the options in the order determined by the remote system.

In the context of a conversation between users in a group, each user device would have access to both a plurality of user selectable questions relating to an item and appropriate user selectable answers. Hence, each user can ask and answer questions using predetermined templates. This can speed up information exchanges on specific items, as all that has to be done is to select an appropriate question or answer and this is automatically entered into the text entry field for sending to the other users.

According to another aspect of the invention, there is provided a system adapted to receive from a plurality of user devices signals indicative of selection of one or more predetermined user selectable questions or answers to questions relating to an item; use the signals to determine an order for presentation of the user selectable item questions or answers and send a signal to each user device to cause the user device to present the questions or answers in the determined order.

According to another aspect of the present invention, there is provided a system for monitoring the use of predetermined questions and predetermined answers related to one or more items within one or more text conversations between two or more communication devices, the system being adapted to receive from a plurality of user devices events corresponding to posts within the text conversation of the predetermined questions relating to an item for all conversations between the user devices within a time period; count the number of posts for each of the questions; receive from a plurality of user devices events corresponding to posts of the predetermined answers; and count the answers posted to each of the questions. Based on the number of counts, the system can rank the questions and answers. The system may be adapted to send a signal to cause the two or more communication devices to present the questions and answers in the ranked order.

According to another aspect of the invention, there is provided a system adapted to receive from a plurality of user devices signals indicative of selection of one or more predetermined user selectable questions or answers to questions relating to an item; use the signals to determine an order for presentation of the user selectable item questions or answers and send a signal to each user device to cause the user device to present the questions or answers in the determined order.

According to another aspect of the present invention, there is provided a system for monitoring the use of predetermined questions and predetermined answers related to one or more items within one or more text conversations between two or more communication devices, the system being adapted to receive from a plurality of user devices events corresponding to posts within the text conversation of the predetermined questions relating to an item for all conversations between the user devices within a time period; count the number of posts for each of the questions; receive from a plurality of user devices events corresponding to posts of the predetermined answers; and count the answers posted to each of the questions. Based on the number of counts, the system can rank the questions and answers. The system may be adapted to send a signal to cause the two or more communication devices to present the questions and answers in the ranked order.

According to another aspect of the present invention, there is provided a communication device that is adapted to enable a text conversation with at least one other device, the device being adapted to present user selectable item information; on the same screen present a user selectable cell or key for enabling a text conversation with at least one other device, wherein on selection of the a user selectable cell or key (a chat or conversation cell or key), the text conversation is presented. Preferably, the text conversation is provided on the same screen as the item information. The item information may be provided from a first remote system, for example a retailer provided system. Selection of the user selectable item information may cause a signal to be sent to the first remote system. The text conversation may be enabled by a second remote system. Selection of the user selectable cell or key may cause a signal to be sent to the second remote system. The device may be adapted to send a synchronisation signal to the other devices to cause display of the item on the lead device on all devices in the conversation.

According to another aspect of the present invention, there is provided a communication device adapted to enable a conversation with at least one other device; determine conversation exchanges relating to an item; and present all conversation exchanges relating to the determined item on screen as a group. The device may be adapted to present the conversation exchanges relating to the item in a single enclosed area, for example a bubble. The bubble may be open or closed. When open, all conversation exchanges relating to the item may be presented on screen as a group.

According to another aspect of the present invention, there is provided a communication device adapted to enable a conversation with at least one other device; determine conversation exchanges relating to an item, and use content of the conversation to determine an approval for the item. The device may be adapted to send information relating to the determined approval to a remote system for storage and analysis. The device may be adapted to send the information in response to detection by the device of user selection of another item.

The device may be adapted to assign an approval for each individual exchange relating to the item and use the individual approvals to determine a single overall approval. The device may be adapted to combine individual approvals to give the single overall approval. Alternatively, the application server may be adapted to combine the approvals.

The approval may be represented by a number. Where the approval is a number, the device may be adapted to combine individual approvals by summing or multiplying the individual approvals.

The device may be adapted to determine an approval by identifying predetermined words indicative of a sense of approval. To this end, the device may include a dictionary of key words that convey a sense of approval. Each key word may be associated with a numerical value according to its degree of approval. For example, “love” (+2), “luv” (+2), “good” (+1), “OK” (+0.5), “bad” (−1), “hate” (−2) where each key word's associated degree is shown in adjacent brackets. Each time the device sends or receives a text message, the message is analysed for the occurrence(s) of the key words and the message's approval is calculated using each occurrence's associated value, for example by summing the associated values. In the preferred embodiment, the member device infers approval for a particular item while it is selected by summing the approvals of all the messages composed by the member device.

According to another aspect of the present invention, there is provided a system adapted to receive from a plurality of user devices approval ratings for a given item, and store the approval ratings.

According to yet another aspect of the present invention, the application server is adapted to allocate a class to a transaction according to whether a type or combination of types of events is logged prior to the transaction event; count the number of transactions for each class over a time period; count the views of the item for the class over the period; and determine a rate. The rate is determined by dividing the count of transactions by the count of views, or by dividing the counts of one type of transaction by the counts of another type of transaction.

### BRIEF DESCRIPTION OF THE DRAWINGS

Various aspects of the invention will now be described by way of example only and with reference to the accompanying drawings, where:

FIG. 1 is a diagram of a chat system for enabling interactive communications relating to one or more items;

FIG. 2 is a diagram of a conversation displayed to the screen of a member's device;

FIG. 3 is a diagram of item related content displayed to the screen of the member's device;

FIG. 4 is a diagram of the conversation and the item related content displayed simultaneously to the screen of the member's another device;

FIG. 5 is a diagram of the conversation displayed to the screen of another member's device;

FIG. 6 is a diagram of an array of multiple question options overlaid upon the conversation displayed to the screen of the member's device;

FIG. 7 is a diagram of an array of multiple answer options overlaid upon the conversation displayed to the screen of the another member's device;

FIG. 8 is a diagram of the conversation messages displayed to the screen of the member's device after the member has selected a question option and after the member device has received an answer from the another member;

FIG. 9 is a diagram of a structure of a data array that is loaded to devices of members of a conversation upon selection for viewing of an item by one of the members;

FIG. 10 is a flow diagram of a method of presenting questions and answers to a plurality of members in a conversation that relates to a specific item;

FIG. 11 is a flow diagram of steps for ensuring that the most popular options are displayed to members;

FIG. 12 is a diagram of the conversation where the representation of item related message information is improved;

FIG. 13 is a flow diagram of a method for entering into a synchronised conversation with other members within a conversation;

FIG. 14 is a diagram of a conversation displayed to the screen of a member's device in a voice call with other member devices of the conversation;

FIG. 15 is a table describing event types that are logged by member devices to a repository;

FIG. 16 is a flow diagram of a method for inferring approval of members' responses to an item;

FIG. 17 shows the results generated by a third party to show for a given item or category of items members' approvals by questions and broken by answers, and retail performances by class of transaction;

FIG. 18 is a flow diagram for classifying a transaction according to the class of conversation in which it occurred;

FIG. 19 shows exemplary event diagrams for classes of transactions; and

FIG. 20 is a flow diagram of a method for determining retail performance of an item by class of transaction.

### DETAILED DESCRIPTION OF THE DRAWINGS

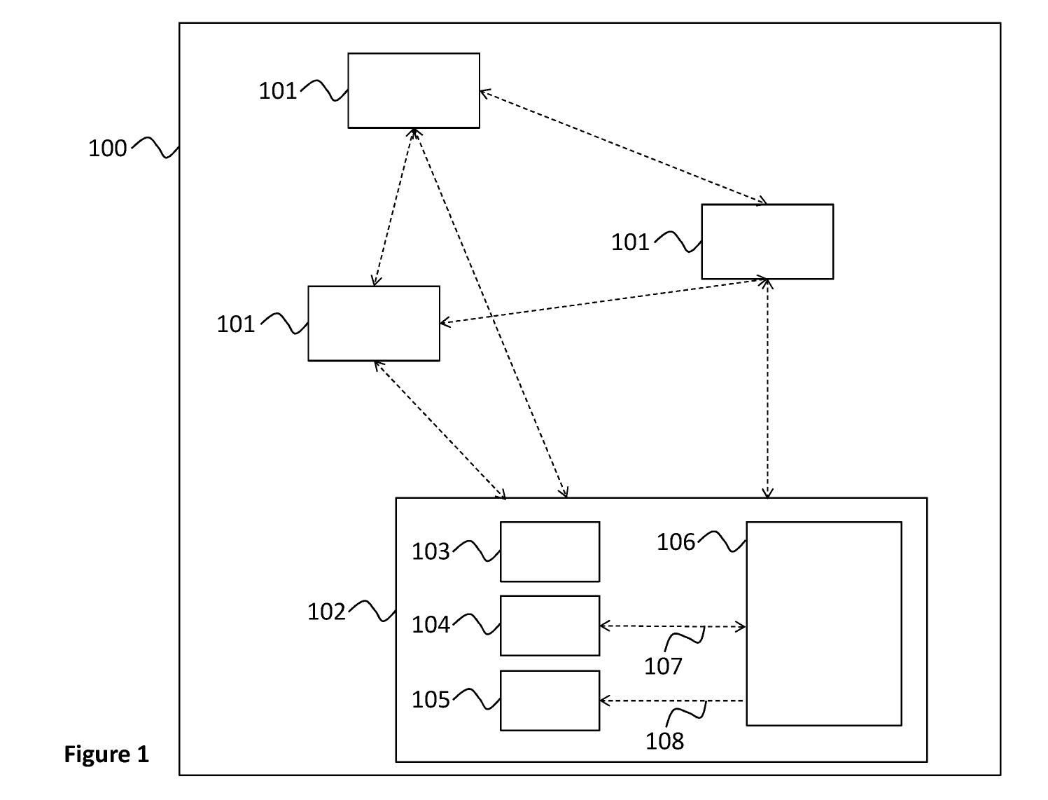

FIG. 1 shows a chat system 100, which comprises a plurality of member devices 101 bi-directionally connected communicatively (dotted lines) to a common chat conversation across the Internet. Member devices 101 are commonly battery powered and portable, and may be smartphones, tablets, personal computers or any computing device capable of display of information to its user and capable of receipt of commands, text, selections, speech and touch inputs from the user. As is commonly known to persons skilled in the art, member device 101 typically employs an operating system such as Android or iOS and is capable of executing software applications installed under the member's control over the Internet from an app store, which are linked to software development libraries comprising functionalities of the processes of this invention including structured query language (SQL), MQ Telemetry Transport (MQTT), web (HTTP) and web real-time communication (WebRTC) clients. The application programming interface (API) and programming environments employed by the applications are widely available, where the applications read and write programmatically to and from volatile and non-volatile hardware memory locations built into the device and where these applications are coupled to and receive member's inputs from either hard key or touch sensitive screen keyboards, are capable of converting audio signals to data received from a built-in microphone, are capable of detecting and processing the device's spatial orientation over time through reading data from sensors, and where these applications write graphical and text images to a built-in screen for display purposes and output data to a built-in speaker for audio transmission purposes.

Member devices 101 are bi-directionally connected communicatively across the Internet to a third party 102 that comprises a web site that has a content repository 103 that serves content relating to one or a plurality of items to member devices 101, a repository of questions and answers relating to the items (“Q&A repository”) 104, an event repository 105 for storing information describing member device 101 actions and a server 106 for the purpose of exchanging messages and call management signals between the member devices 101 (“message server 106”) as later described.

In the embodiment described, content repository 103 comprises an Apache web server. Devices 101 may periodically be absent from the Internet and consequently exchange messages via message server 106 which comprises an open source Mosquito v1 message broker using the public MQ Telemetry Transport (MQTT) publish-subscribe protocol. Alternate message protocols can be used, including the XMPP protocol. Q&A repository 104 comprises a MySQL database that serves question and answers 107 prepared in advance by third party in relation to the item descriptions retrieved from content repository 103 to devices 101 via message broker in message server 106. Event repository 105 comprises a MySQL database that stores event data 108 inserted by devices 101 via message broker in 106. Devices 101 establish audio calls with other devices 101 via peer-peer data streams, exchanging management signals via a WebRTC server also comprised in message server 106.

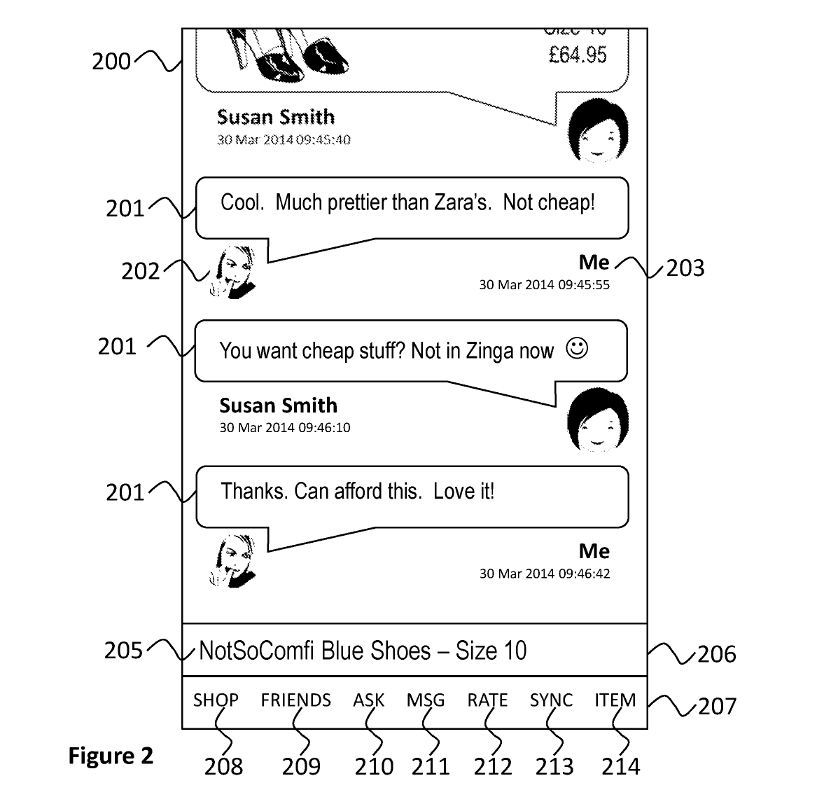

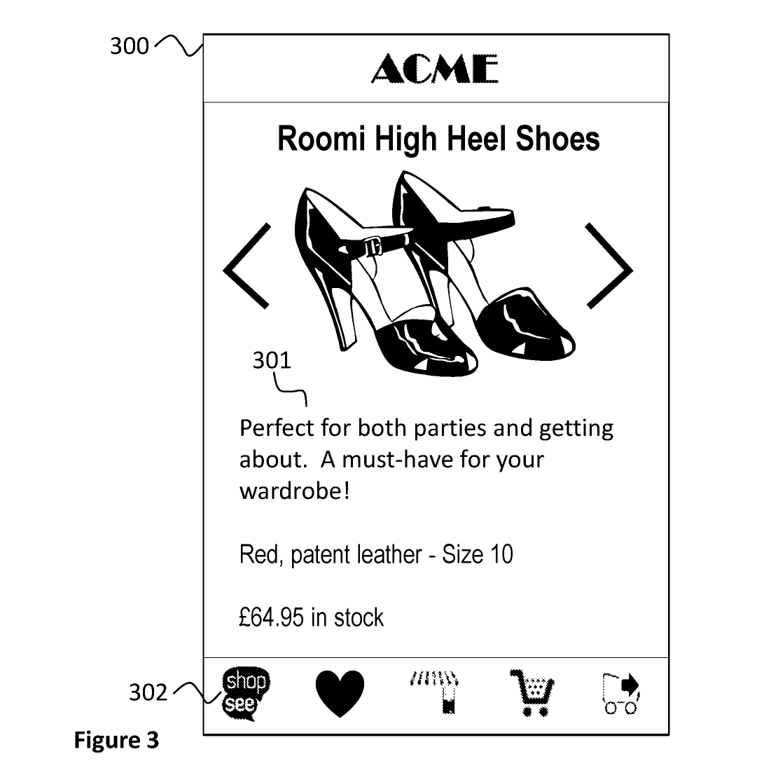

FIG. 2 shows a chat conversation scene 200 displayed to the screen of device 101 generated by an application installed on the device. Scene 200 comprises messages 201 received by the device from, or broadcast by the device to, other member devices of the same conversation displayed vertically in time order (“chat representation”). The messages are enclosed within chat bubbles where each bubble may contain a text message associated with the identity of a member device 203 and may be annotated with an avatar or photograph 202 of its authoring member. Chat scene displays details of a subject of the conversation 205 (e.g. “NotSoComfi Blue Shoes”) where the subject corresponds to an item selected from an application 205 present on device 101. Details 205 may comprise the item's name, a text description and one or a plurality of images. Toggling details 205 causes it to be displayed in reduced (e.g. name only) or expanded form to include more information (not shown). In the embodiment described, an item is an article or service for sale, rental, return or other transaction. In other embodiments an item may more generally comprise a topic whose content is not displayed, or is partially displayed, within a chat conversation by the member device. The display contains one or a plurality of panels 207 containing user selectable cells 208 thru 214 to control the member device and conversation. Selecting the cell 208 causes the member device to swap execution to a third party's application such as a retail application, as later described in FIG. 3. To view or alter the membership of the conversation user selects cell 209 to cause the member device to list the membership and user's friends for selection/de-selection. Members of the conversation may broadcast a text message into the conversation by selecting cell 211 to cause a keyboard to be displayed to allow composition of a message. The keyboard and message may include QWERTY and emoticon characters. In other embodiments a message may be recognised from speech dictated by the member into his/her device's microphone where speech recognition is known to persons skilled in the art. Selection of cell 212 causes the member device to display rating choices for the item 205, comprising for example a list of stars or thumbs up/down. Selection of the rating choice causes the item's identity and the rating choice to be posted into the conversation for display to the members.

FIG. 3 shows a content scene 300 comprising item related content 301 displayed by the third party application as an exemplary retail item for sale. User selects control 302 to navigate to chat scene 200. On selection of 302 device 101 displays a pop-up control (not shown) requesting user confirmation to post the displayed content item 301 to scene 200 (“Roomi High . . . ”) as the subject of the conversation 205. On confirmation device 101 broadcasts the subject item's identity to the other member devices of the conversation and displays conversation scene 200 with the subject details 205 updated as the subject item. In a preferred embodiment, the user toggles between scenes 200 and 300 by pressing a same physical location, 208 and 302, on the screen. Scene toggling is further achieved by detecting a physical gesture applied by the member to the device such as a momentary rotation of the device 101 about an axis or shaking of the device.

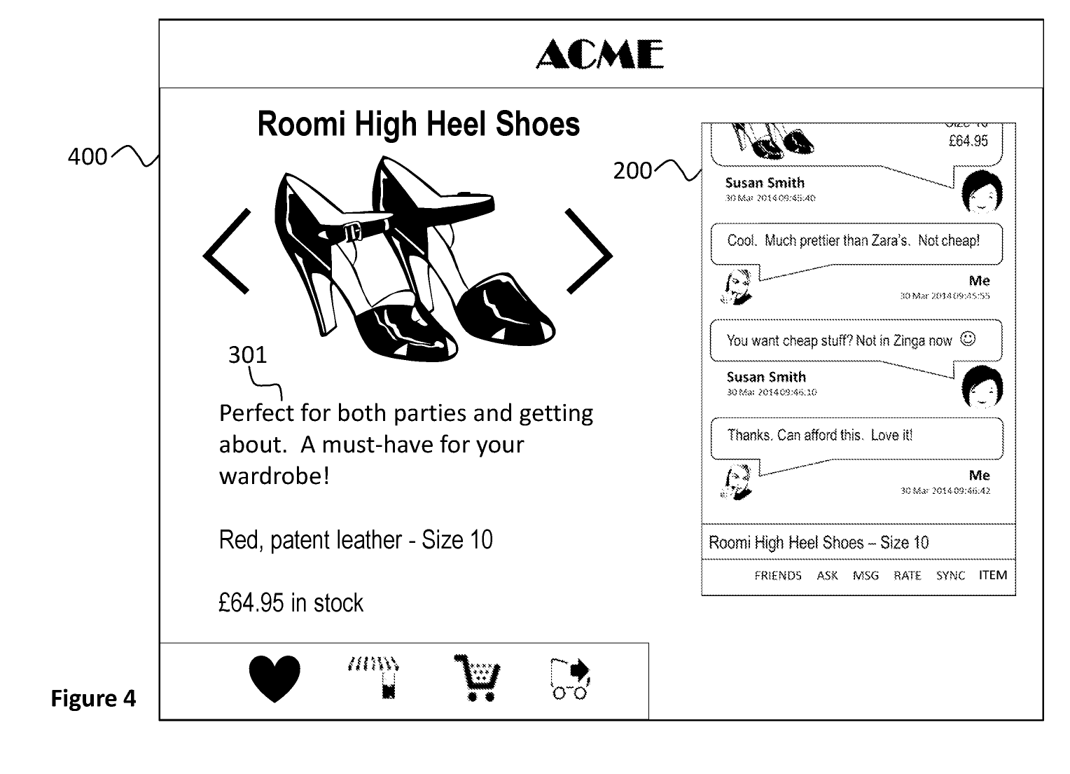

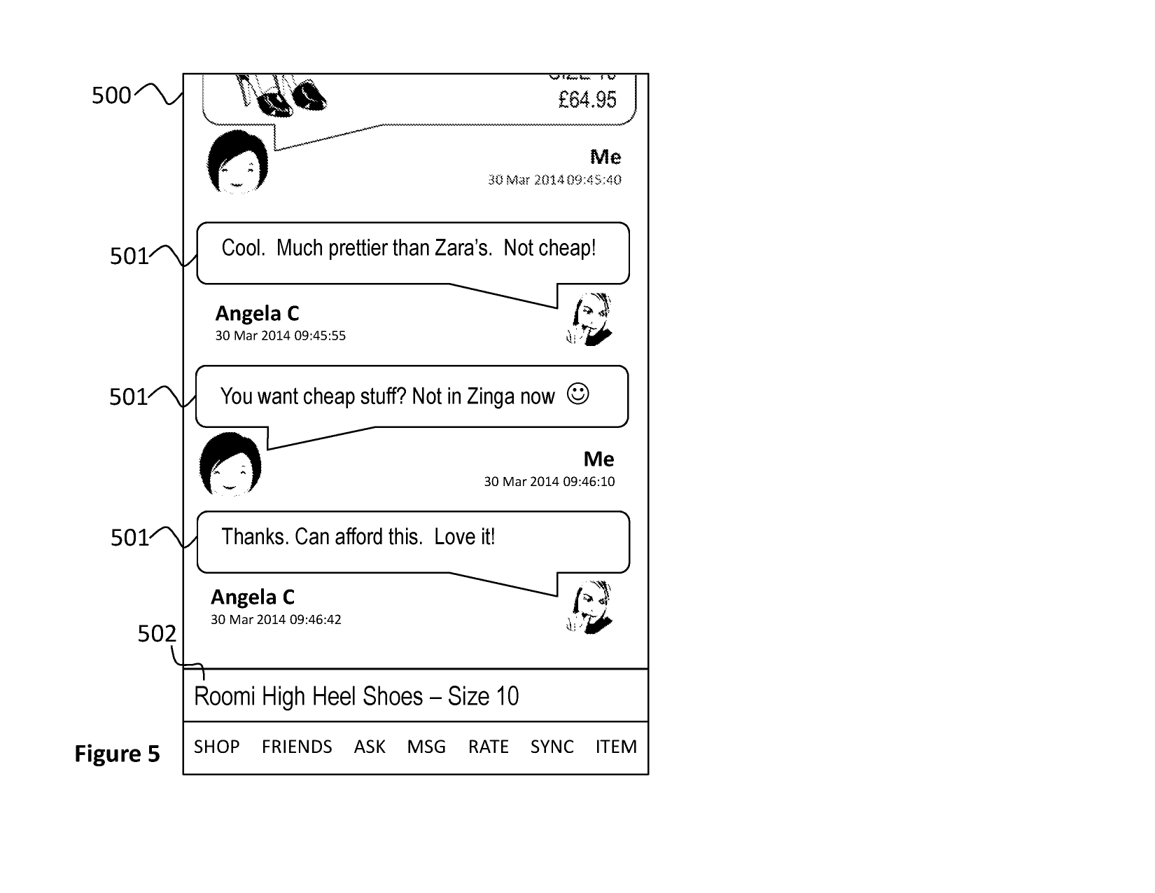

FIG. 4 shows the display 400 on a screen of a member device 101 whose size is sufficient to accommodate conversation 200 and item descriptions 301 simultaneously. FIG. 5 shows another member's device 101 displaying the same conversation 500 as visible in 200 to the first member displaying subject item 502.

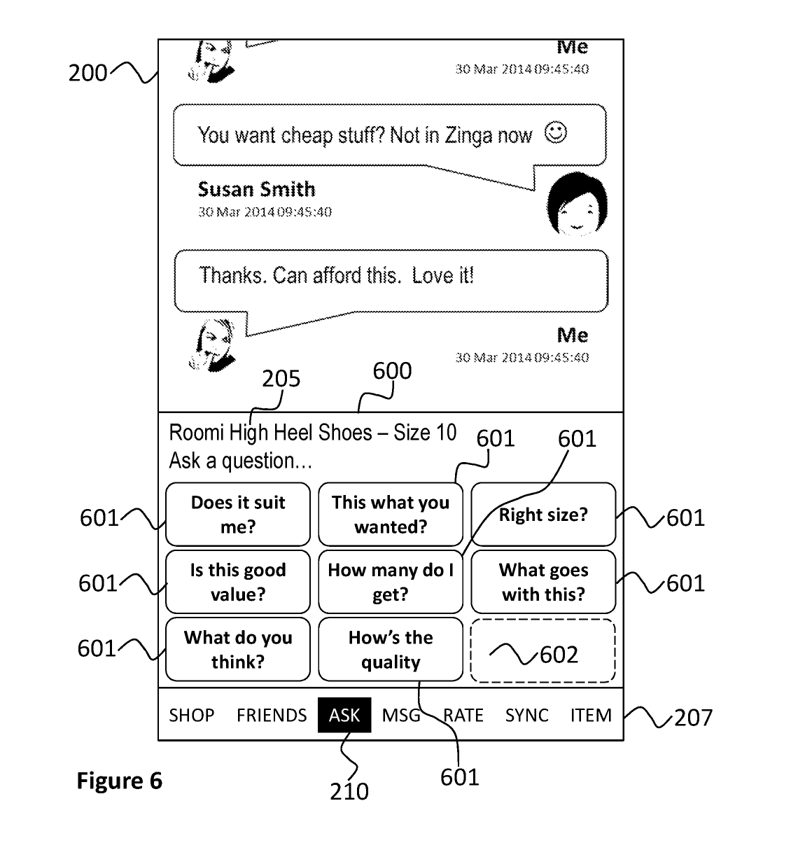

Third parties typically face problems elucidating questions raised by users with respect to subject items. The embodiment described employs a multiple question per item approach to elucidate selected question, and is described as follows. FIG. 6 shows a member causing a palette of questions 600 to be displayed by selecting a cell corresponding to an icon or label (for example “ASK”) 210. Palette 600 contains an array of cells 601 each associated with a question. The array may be incomplete, featuring one or more blank cells 602. Member hides palette 600 by toggling selection of cell 210 causing, if a question is selected, a chat bubble containing the selected question to be displayed in timeline 200 of member devices party to the conversation.

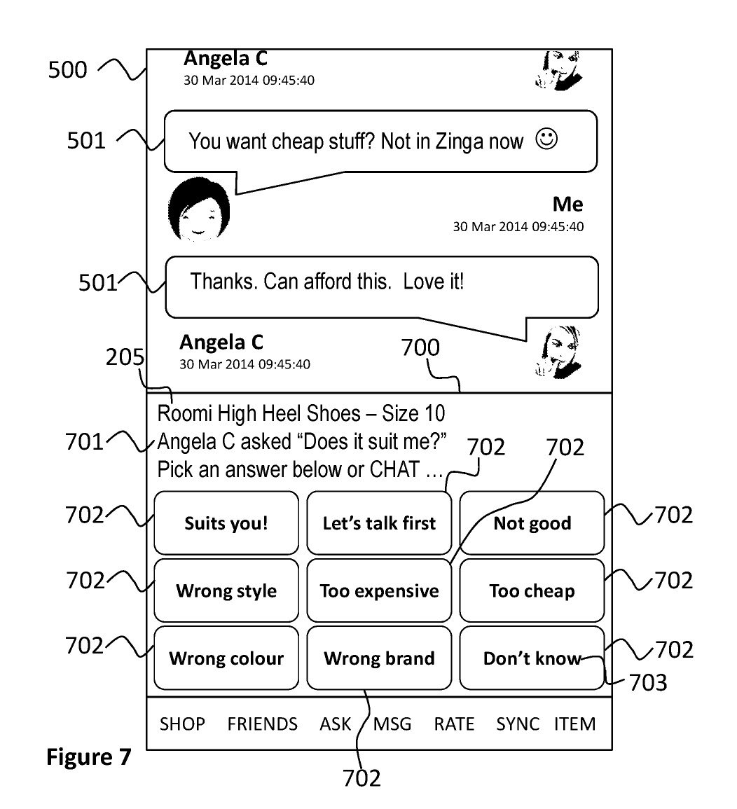

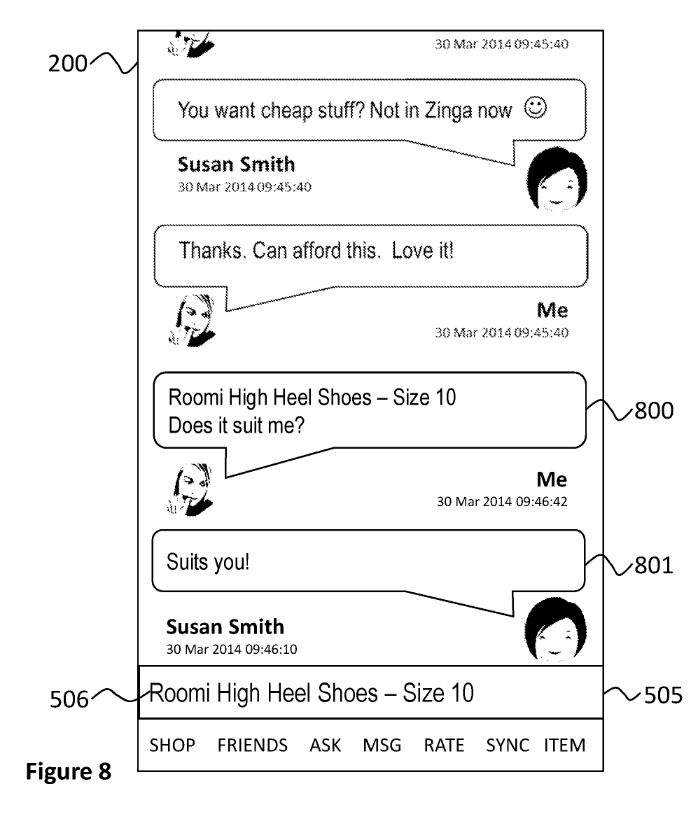

FIG. 7 shows another member's display 500 and how member's selection of question cell 601 causes a palette of answers 700 to be displayed on the other members' timeline display(s) 500. Palette 700 partially hides other members' item name 502 and conversation bubbles 501 and/or displaces them upwards and off-screen. Palette 700 displays the asking member's identity 701 and item name or description 205, and contains an array of cells 702. Each cell 702 displays a possible answer to selected question 601. Selecting a cell 702 causes its answer to be broadcast to all other members of the conversation as a message within a chat bubble. FIG. 8 shows the member's display of conversation 200 with the asked question 800 and a received answer 801. The processes described convey convenience to members because relevant questions and answers can be readily identified without requiring them to be manually typed out.

A member may select a particular question (e.g. “Is this good value”) with respect to the subject item 205. Knowledge of the relative frequency with which questions are selected with respect to an item would allow retailers to understand their relative overall importance. Consequently, it is advantageous for third party 102 to measure the absolute and comparative frequencies with which questions are asked in respect of the subject item. Further, it is advantageous for retailers to know how frequently members respond with certain answers to particular questions in respect of the item. For such a system of exchanging questions and answers between members to be useful to its members, the time delay between selection of a question and receipt of its answer must be minimised to typically less than a second. Mobile handheld devices that connect wirelessly to the Internet normally have below average bandwidth connections and experience higher latency times compared to fixed line connections. Methods are required as a consequence to minimise the delay between question selection and answer display.

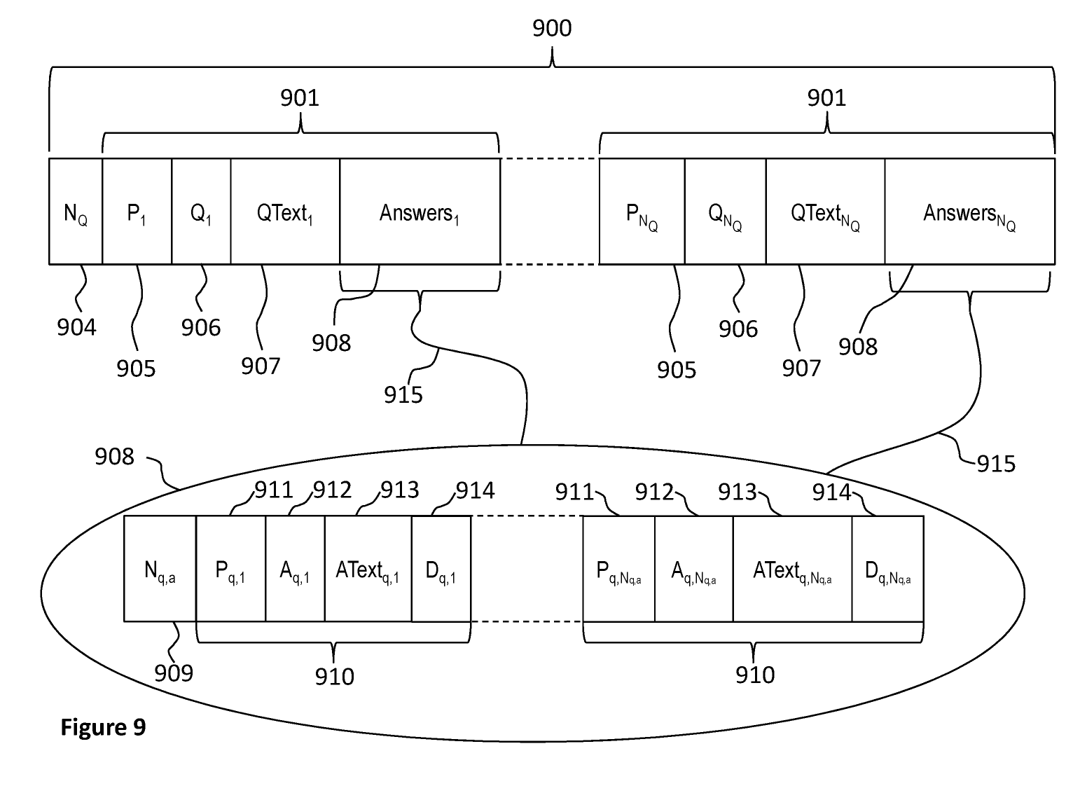

FIG. 9 shows an arrangement of data 900 where all members to a conversation pre-fetch simultaneously an arrangement of structured question and answer data in response to a member's selection of an item. The arrangement contains an integer, N_{Q} 904, for the number of questions contained in the arrangement for the selected item followed by data block, 901, for each question q. Each block 901 contains an integer number to describe its priority P_{q} 905 to allow the member's device to determine whether and in which cell 601 of palette 600 to locate display of the question text, a unique identifier Q_{q} 906 for the question, the question's text string QText_{q} (for example “Does it suit me?”) 907 and is linked 915 to a sub-block 908 comprising possible answers for selection by the asked members. Sub-block 908 starts with the number of possible answers to the relevant question block 901, N_{q,a} 909 and follows with an answer block 910 for each answer a. Answer block 910 contains the answer's priority P_{q,a} 911 for display within cells 702 of array 700, a unique identifier for the answer A_{q,a} 912, the answer's text string AText_{q,a} (for example “Looks great on you”) 913 and a numeric degree of approval TD_{q,a} 914 associated with the answer to be described later. In the preferred embodiment, the text components 907 and 913 are data compressed and palette 900 is bit packed into a single, binary blob to minimise the size in order to reduce the bandwidth required by the member devices to pre-fetch the arrangement 900 and to minimise communication latencies by allowing the arrangement to be retrieved from Q&A repository 104 in single fetches.

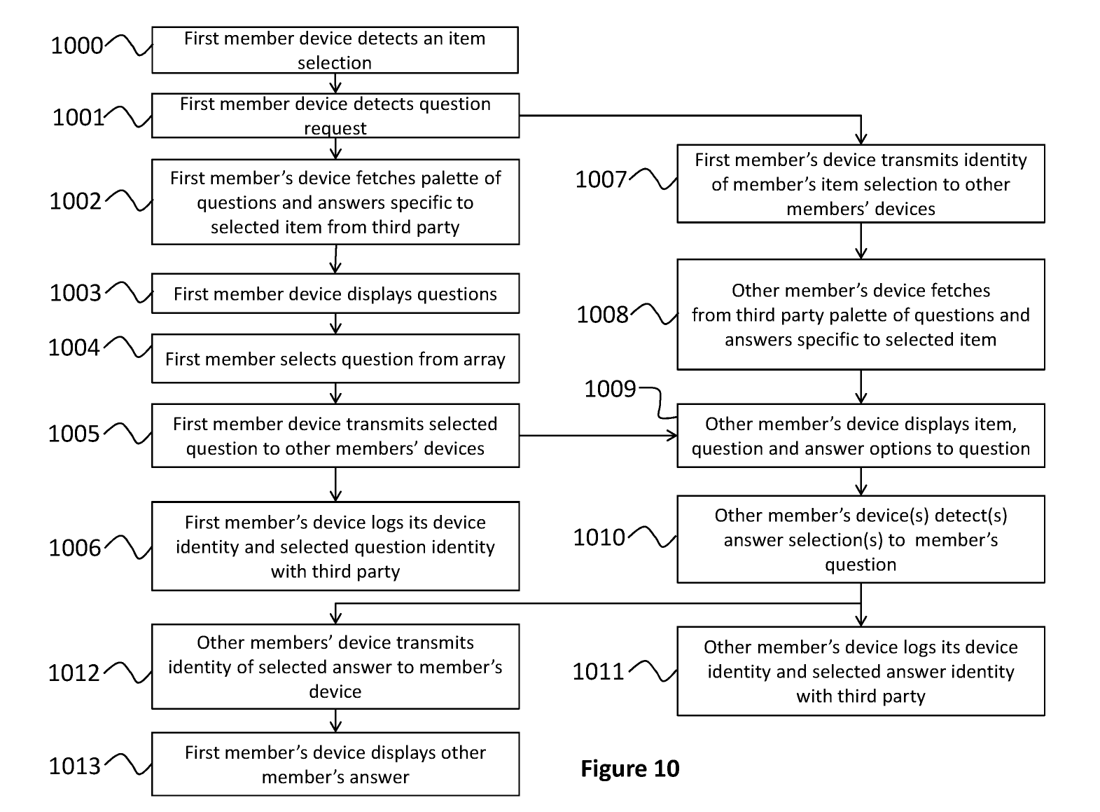

FIG. 10 shows the steps involved in communicating questions and answers using arrangement 900. A first member device determines selection of an item as the subject of the conversation (step 1000) from a display of items 300 or 400 and identifies the selected item to the user in area 206. The first member device detects selection of the question functionality, such as selection of cell 210 (step 1001). Steps 1002 and 1007 may be performed concurrently after step 1001 to minimise latency. The first member's device fetches the arrangement 900 from Q&A repository 104 (step 1002). Returning to step 1007, the first member's device transmits the selected item's identity to the other members' devices. Upon each receiving the identity of the selected item, the other members' devices fetch arrangement 900 for the selected item from Q&A repository 104 (step 1008). In alternative embodiments, the first member device may broadcast the whole, or part, of the arrangements 900 to the other members' devices directly. In yet other alternative embodiments, the fetching steps 1002 and 1008 occur immediately after item selection step 1000. Q&A repository 104 generates arrangement 900 as zlib compressed JSON objects for each item described in content repository 103. The generating step is performed off-line to minimise user experience of time delays from generation at fetch steps 1002 and 1008. In the embodiment, the fetch steps retrieve arrangements 900 from Q&A repository 104 via message broker 106. In other embodiments, arrangements 900, 901 and 908 may be replaced by links to data stored in and fetched from a remote server such as repositories 103 or 104. On selection by the member of cell 210 to activate the multiple question function the member's device decodes the arrangement 900 to obtain the question texts 907 and displays them as question cells 601 within array 600 (step 1003). Upon the member's selection of a question cell 601 (step 1004) the member's device transmits the identity of the selected question, Q 906, to the other members' devices (step 1005) and logs the member's identity and Q as a PQ event (see later) to event repository 105 (step 1006), withdraws display of the question array 600 and displays the selected item name and question 800. Upon receipt of Q the other members' devices display the selected item's name 205 within a palette 700, the fixed question text 701 corresponding to the Q 601 selected at step 1004, and displays in cells 702 the fixed answer texts 913 comprised within the answer block 908 that links 915 to the question block 901 corresponding to the selected Q 913 (step 1009). Each of the other members may select one of the answer options 702 (step 1010), causing their respective devices to log their respective identities and the respective identities of the selected answers A 912 as a PA event (see later) to event repository 105 (step 1011) and A 912 to be transmitted to the member's device (step 1012), and for the member's device to display the other members' answer(s) 801 (step 1013). In the preferred embodiment steps 1000 to 1013 are implemented using a native software application that is preloaded to the member devices. The application executes over a device platform application programming interface (API) such as Android or iOS. In other embodiments the steps may be implemented in the member device as web browser executable JavaScript software downloaded at the beginning of or during steps 1000 to 1013 from a web server such as 102.

Mobile devices vary significantly in size so that what is practical in terms of a number of questions or answer options to display on one device is impractical for display on another device. Consequently a problem remains as to what size of palette array in terms of numbers of questions and answers is suitable for display in 600 or 700. The problem is addressed by causing member devices to each display the questions and answers with the N_{d} highest priority P values, 905 and 911 respectively where N is the size of the array used by particular device d.

Another limitation of displaying question and answer options is that a probability of selecting an option may be biased according to the option's displayed position in an array. For example an option displayed in a first position in an array is typically more frequently selected than the other options irrespective of their meanings. As later described the relative frequencies of the questions and answers logged at steps 1006 and 1011 may be counted by the third party for research purposes so that means are required to correct the positional biases introduced by the orderings of the questions and answers enumerated within arrangement 900. This is addressed by causing the member devices to display the respective questions 601 and answers 702 in pseudo-random positions relative to each other.

A yet further problem is that certain responses (e.g. “Don't know”) to questions should not be randomised but, instead, displayed always in the same position in array 700 (e.g. at the end). The problem is addressed by adding a randomisation parameter, R_{Q}, to the beginning of arrangement 900 to limit randomisation of display positions to the R_{Q} questions with highest priorities P_{q} at step 1003. Similarly a randomisation parameter, R_{A}, is inserted at the beginning of each answer sub-block 908 to limit randomisation of display positions to R_{A} answers with the highest priorities Pₐ at step 1009. Means are further required to ensure that fixed questions and answers are always displayed irrespective of a display's availability to display a particular number of options, otherwise common responses may be truncated and omitted if the display's availability is too small. For example, if the display of FIG. 7 had insufficient availability to display 9 cells 702, the “Don't know” response 703 would be omitted. To address this, a parameter, F_{Q}, is further included at the beginning of arrangement 900 that denotes a number of questions that must always be displayed in a fixed position in array 601 at step 1003. Similarly, a parameter, F_{A}, is further included at the beginning of each sub-block of answers 908 to denote a number of answers that must be displayed in a fixed position in array 702 at step 1009.

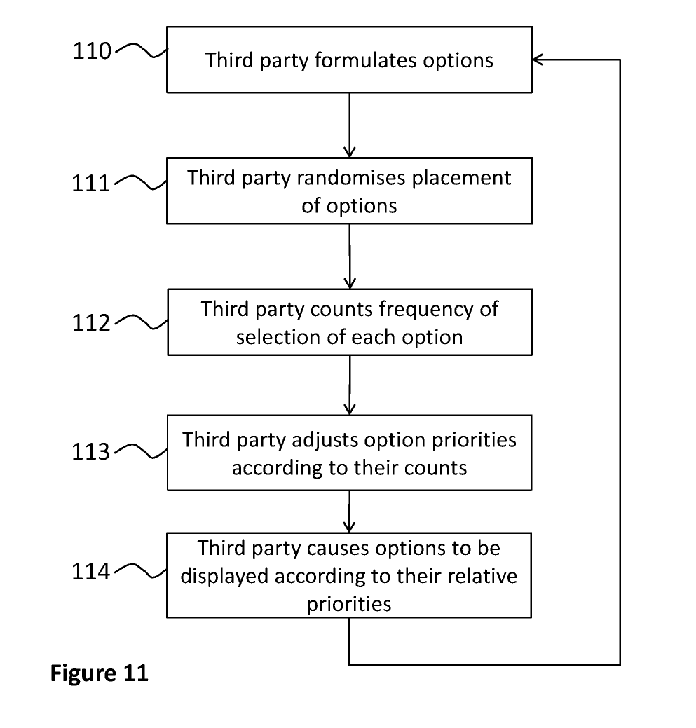

Members are likely to benefit from selection of the question and answer functionality described provided the Q and A options (601 and 702 respectively) are sufficiently relevant to both the item and to the members of the conversation. The third party may inadvertently compose options that are never or rarely selected. Conversely, the third party may compose a highly relevant option that should always be displayed, but which is not displayed because its priority is set incorrectly low compared to those for the other options. Accordingly a method is applied as shown in FIG. 11 to adjust periodically an option's priority so as to ensure that most popularly selected options are most likely to be displayed. The third party formulates and stores a number of Q response options, and a number of A response options to each Q, for an item (step 110) to Q&A repository 104. Q&A repository 104 adjusts the option's randomisation parameters R_{q} and Rₐ previously described to give all options equal probabilities of being displayed randomly in any position in an array on member devices' displays (step 111). Q&A repository 104 counts and stores the number of selections of each option by members across all conversations for the item over a time period sufficient to obtain statistical validity for option ranking purposes (step 112) to Q&A repository 104. Q&A repository 104 adjusts the priority P value for each option so that P is proportional to the count of option selections at step 112 (step 113). Q&A repository 104 resets the options randomisation parameter R as previously described to display all options in order of their new adjusted priorities P (step 114). The preferred embodiment avoids subjecting users of the whole population of member devices to randomised displays by causing each of a proportion of the population to become randomly a member of the subset, periodically applying steps 110 to 113 to the subset and, finally, applying the adjusted priorities P to the whole population at step 114.

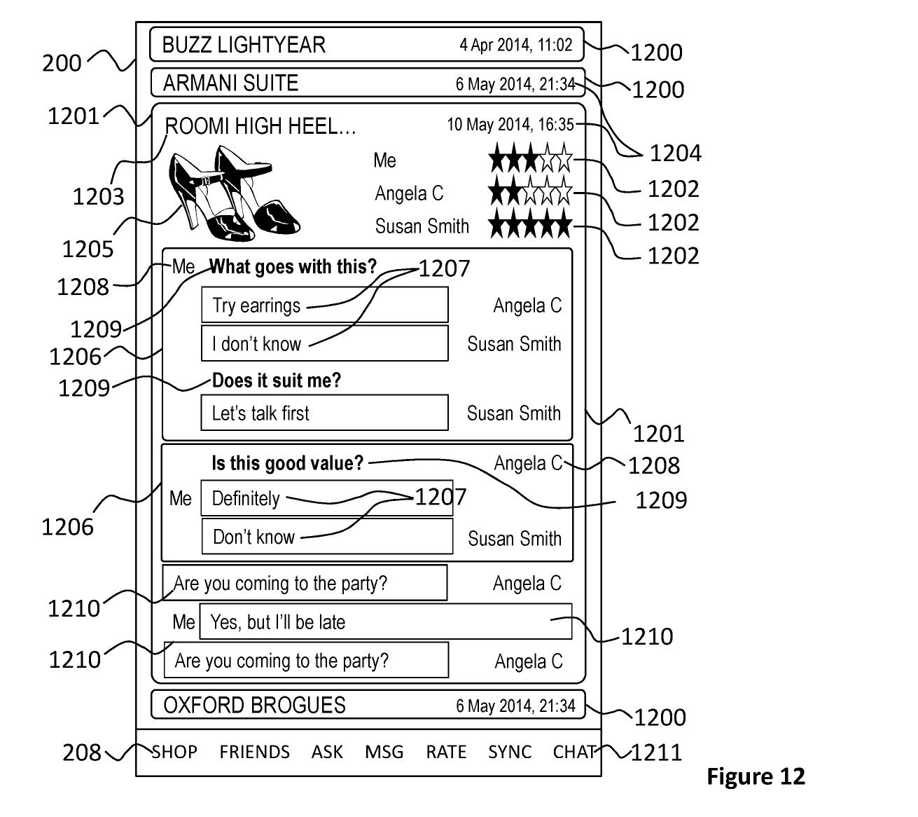

A means responsive to selecting cell 214 on display 200 is provided to redraw content in a changed representation. FIG. 12 shows a method for displaying item related information in an “item” representation. In this method references to an item are enclosed within a single enclosed area (“bubble”). An item bubble may be closed, shown by 1200, so as to show only the item's name or identity 1203 and basic information such as time and date of the last addition of content 1204. An item bubble may have an open state so as to display relevant content as shown by 1201 which may include graphical information (e.g. photographs) and/or text descriptions 1205. In the preferred embodiment, a single item bubble is open at a time whose identity corresponds responsively to identity of item 301 selected in retail application 300 or 400. Alternately, the open bubble may correspond to selected subject items 205 and 502. Touching a closed item bubble 1200 causes the bubble to change to the open state 1201, causing the retail application to select immediately the item description 301 corresponding to the item associated with the opened item bubble on display 400, or on display 300 when cell 208 is next selected. Accordingly, the benefits of the item representation are that a member perusing item descriptions 400 within a retail application on a tablet sees immediately a whole discourse on the item of interest. Similarly members perusing item descriptions 300 on a smartphone are required to make only a single gesture (selecting cell 302 or rotating/shaking the device) to perceive the discourse.

In the preferred embodiment, item bubbles are ordered vertically in order of the time 1204 of the latest addition of information to each. Referring to the open bubble 1201 information is located within the bubble so that content of the same type, for example star ratings content 1202, are adjacent to each other.

Questions asked by a member 1209 and their answers 1207 are displayed located to an area that does not overlap questions asked by other members or answers to other members. Similarly answers 1207 are displayed with the question they answer 1209 in an area 1206 that does not overlap other questions or answers to other questions. Content that is unrelated directly to the item, for example interactive chat texts 1210, is located within open bubble 1201 or between closed bubbles 1200 in an area that does not overlap with content that references the item to which the bubble refers. A means responsive to selecting cell 1211 on display 200 is provided to redraw content in another representation such as the chat conversation representation where posts are arranged in time order. For example, a member may prefer to change representation of the conversation from the item representation to the chat representation if his/her interest has switched from an item related post 1207 to a non-item related post 1210.

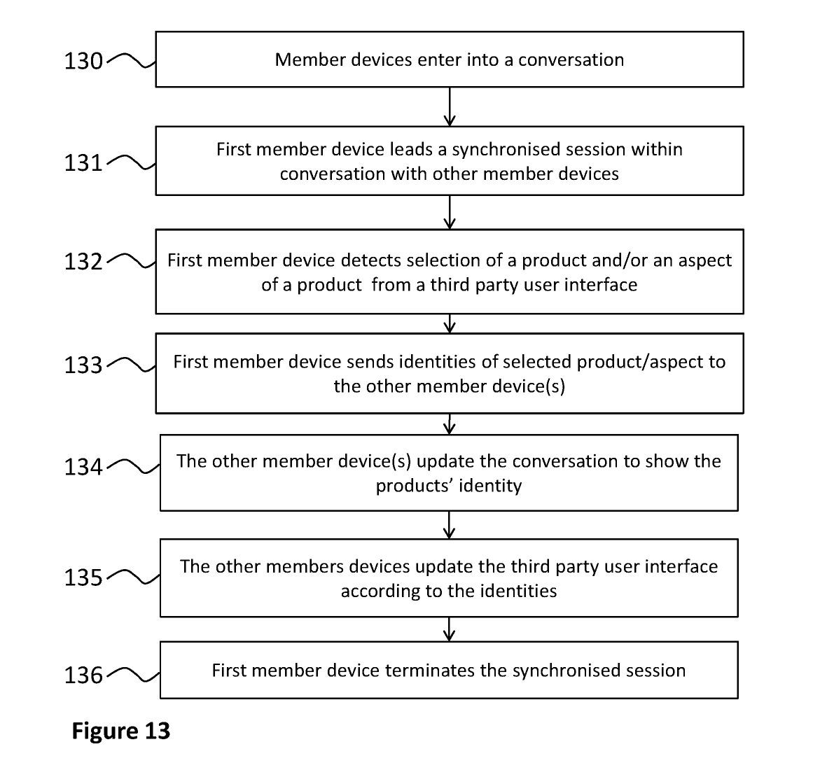

FIG. 13 shows steps in a synchronised conversation, where member devices to a conversation are coordinated to display a same item where the item's identity is selected by one of the member devices (the “leader”), as is taught further in WO2013175236 the contents of which are incorporated herein by reference. Synchronisation allows members to share and access item descriptions more quickly and reliably than in a non-synchronised conversation. Member devices enter into a conventional conversation where each device may select a different item and chat messages may be posted into a common conversation timeline 200 (step 130). A first of the member devices forms a synchronised conversation session with one or more of the other member devices on detection of selection of a cell 213 within panel 207 (step 131). The first member device detects an item 205 selected within user interface 300 or 400 and assigns an identity to the detected item such as a universal resource locator (URL) or an alphanumeric identifier code such as a stock keeping unit (SKU) (step 132). Retail user interfaces typically show multiple aspects of an item (for example a photograph of a front view of the item, a side view of the item, a video of the item) so that the first member device detects also the detected item's aspect and assigns the aspect an identity during step 132. The first member device sends the identities of the detected item and detected aspect to the other member device(s) (step 133) either directly or via message server 106. The other member device(s) update the conversation timelines 200 to show the item's identity 205 as corresponding to the detected item identity (step 134). The other member device(s) update display of user interface 300 or 400 according to the detected item and aspect identities (step 135). The first member device terminates the synchronised conversation and sends a termination message to the other member device(s) (step 136).

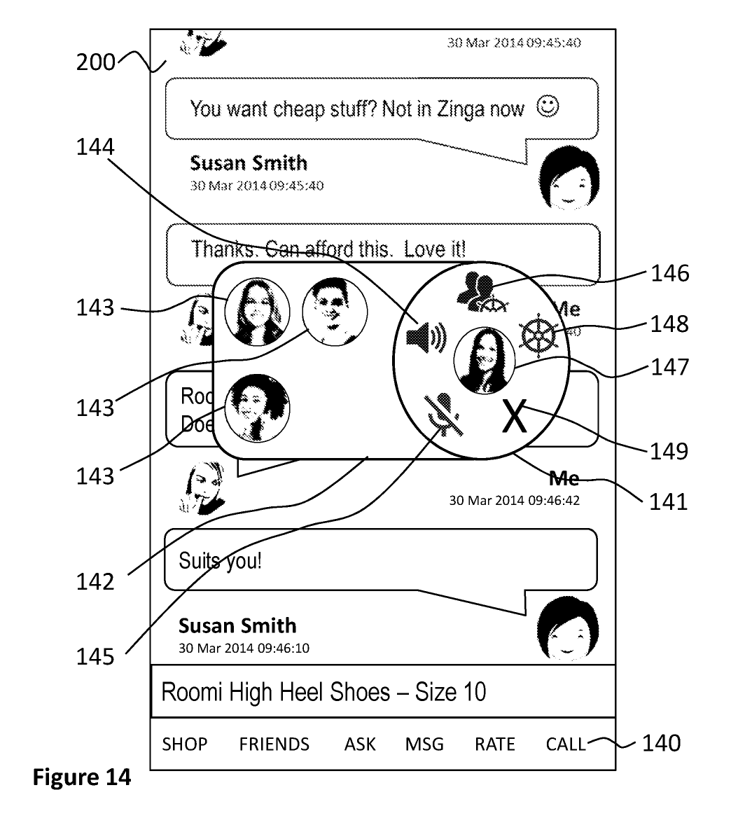

FIG. 14 shows an alternative embodiment of a chat system with synchronisation where members of a conversation manage speech calls and item synchronisation sessions are initiated within the calls. Member devices of a conversation display call control 140 to start or join a call. On user selection of 140 on one of the devices the other devices (not shown) display a pop-up invitation comprising controls to join or ignore the call. On first selection of the join option the starting and joining devices each display hover control 141. When a call is in progress between devices of a conversation, a device not in the call highlights its call control 140 differently (such as by flashing) to indicate that the control can be selected to cause the device to join the call. Control 141 persists while the displaying device is in call and clears upon selection of sub-control 149 to leave the call or upon the call otherwise terminating. To allow members to manage the call while they are joined to it control 141 is overlaid upon and hover over whatever scenes are present immediately prior to joining and during the call. To reduce visual occlusion of the overlaid scene control 141 may be minimised or moved by selection of sub-controls (not shown). On display of control 141, a palette 142 comprising identifiers (e.g. avatars or initials) of the other members of the conversation 143 emerges by sliding out from beneath 141. Identifiers 143 are highlighted to show members in the call. Control 141 comprises sub-control 144 to toggle operation of phone and loudspeaker, sub-control 145 to mute and unmute the microphone. On first selection of sub-control 146 the other calling devices display a pop-up invitation comprising controls to accept or reject (not shown) a synchronised item display session in scene 300 or 400. Sub-control 146 changes appearance while the session is active (e.g. from “Sync” to “Stop”) to signify that re-selection toggles the device to leave the session. Identifiers 143 are highlighted to show members in session. On a synchronised member acquiring leader status the corresponding avatar moves from slider 142 to centre of control 141 (147). Selection of sub-control 148, displayed only on the follower devices, causes the leader device to display a pop-up requesting swap of leader-follower statuses with the selecting device. Selection of sub-control 149 causes control 141 to clear and device to leave the call and the session if in progress.

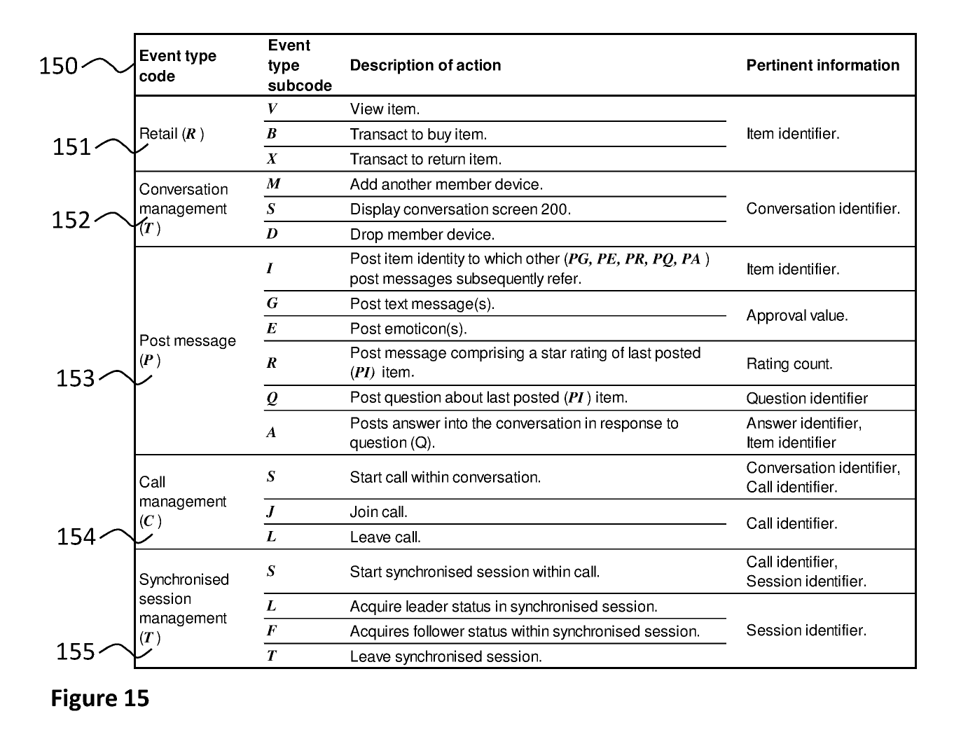

FIG. 15 shows types of events: retail, conversation, post, call and synchronised session events. Each event is logged to event repository 105 and comprises a type identifier, information pertinent to the type, a hash of the member device's unique identifier and an incrementing event counter. Retail events 151 correspond to viewing (RV), buying (RB) and returning (RX) items. Conversation lifecycle management events 152 correspond to forming (TM), viewing (TS) and ending (TD) a conversation. Post event codes 153 each correspond to a type of message broadcast from one member device to other member devices within a same conversation. Types include identifying a subject item for discussion (PI) to which events with the following types subsequently refer: texts (PG), emoticons (PE), ratings (PR), questions (PQ) and answers (PA). Message may be associated with a degree of approval to buy the item identified by an PI or RV event. Approval is a number with a magnitude according to its degree and a sign according to whether the approval is positive or negative for disapproval. In the embodiment described, each member device stores a dictionary of key words that convey a degree of approval and assigns each a numerical value according to its degree such as, for example, “love” (+2), “luv” (+2), “good” (+1), “OK” (+0.5), “bad” (−1), “hate” (−2) where each key word's degree is shown in adjacent brackets. Each time a member device posts a text message the message is scanned for the occurrence(s) of the key words and the message's approval is calculated from the sum of each occurrence's associated value. For example, the message “I love those good shoes” sums to a +3 approval using the key word example given. In the preferred embodiment, predictive text and phonetic Metaphone 3 algorithms are applied to input text prior to scanning in order to minimise dictionary look up fails due to misspelling. The member device infers approval for a particular item while it is selected by summing and averaging the approvals of all the messages composed by the member device. To minimise bandwidth and server loading the preferred embodiment logs a single PG event for all text message broadcast actions during display of the currently viewed item when the next item is selected for view or becomes the subject, or when the member device is switched off or when the third party application is suspended.

The calculation of approval may be performed either in the member device or in event repository 105, or in some combination of both. In the preferred embodiment, the approvals are calculated in the device and logged to event server 105 with each PG event in order to ensure privacy of members' message content. Other methods of calculation are possible such as, for example, by using a function of the item of the key words' approvals.

The value of a PR event is in proportion with the number of stars expressed in the rating. PE events may be pre-assigned approvals by the third party according to each emoticon's meaning where, for example, a smiley or thumbs up emoticon may be associated with a high +1 approval value, whereas a sad face or thumbs down emoticon may be assigned a negative or low −1 value. Similarly fixed answers are pre-assigned an approval value D 914 according to their meanings. For example encouraging answers such as “Suits you!” are assigned a +1 approval value, whereas neutral responses such as “Don't know” would be assigned a neutral 0 value and negative responses such as “Not good” are assigned a negative −1 value. Yet other functions and algorithms such as those widely used for natural language processing known to persons skilled in the field may be employed to elucidate questions and extract approvals from the text messages and speech calls.

Call management events 154 record a member device of a conversation starting a voice call (event CS) and member devices joining (event CJ) or leaving the call (event CL).

Synchronised session lifecycle events 155 record formation of a session within a call (event SL), the state of member participants of the session (events SL and SF) and the session's termination (event ST) as previously described. A member who starts a synchronised session becomes the session's leader by default and logs the session's first lead (SL) event. Member devices that join the session follow and log an SF event. In the embodiment described each member device logs events as a structured query language (SQL) record to event repository 105. Other event types are possible, such as for example a device member transferring an item for viewing to a second screen device such as a television or rotating or controlling the display of the item as taught in WO2013175236 and may be recorded as events and processed.

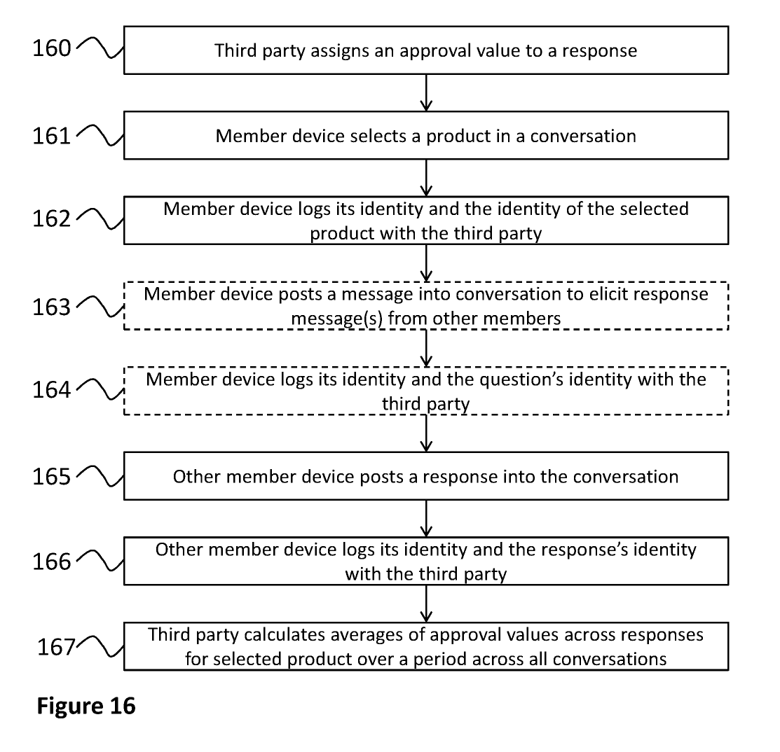

FIG. 16 shows a method for determining an approval rating for an item across multiple conversations. The third party assigns approval values to each post action as previously described (step 160). A member device selects or posts an item into a conversation (step 161). The member device logs the RV or PI event with event repository 105, identifying itself typically using a universally unique identifier (UUID) or a hash of the UUID to preserve member anonymity, identifying the item typically with a stock keeping unit (SKU) or similar identifier (step 162). Member device may optionally post a message to elicit response(s) from the other members (step 163). The eliciting message may comprise an identity of a question elucidated by detecting selection of a fixed message such as a question 601 or, alternatively, may comprise a text message. If the eliciting message is fixed, the member device logs its identity and the question's identity as a PQ event to event repository 105 (step 164). Other member device posts a response to either the item selection in step 161 or to the elicitation posted in step 163 (step 165) and then logs its identity and the details of the response as an event to event repository 105 (step 166).

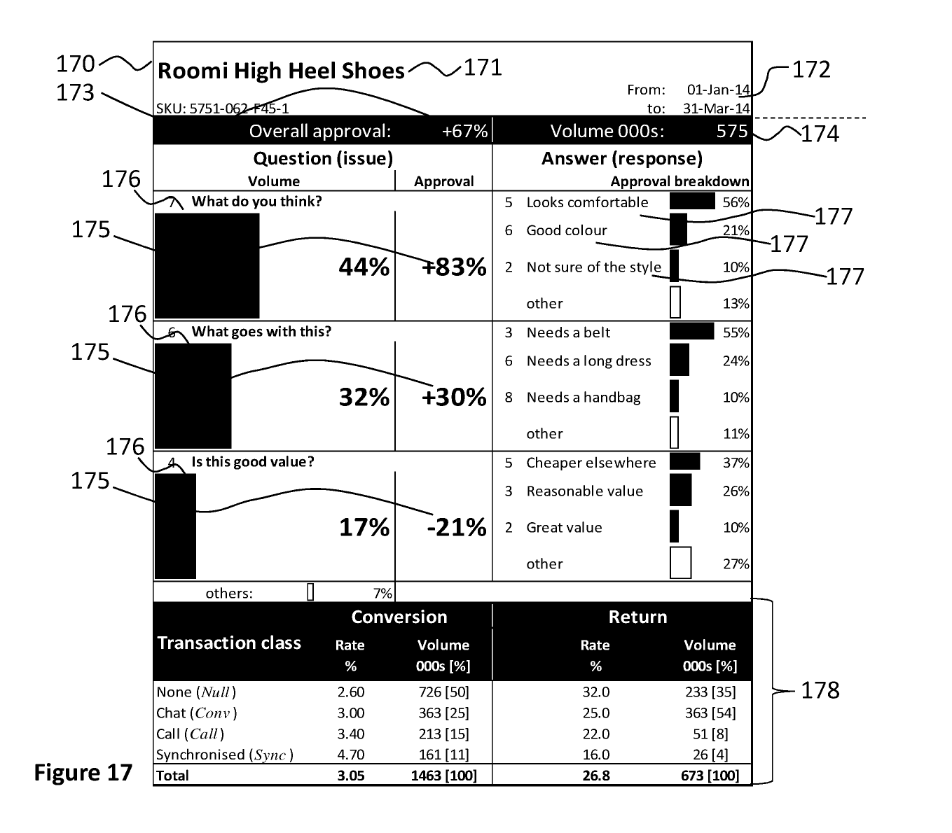

Due to variable transmission delay times logged events may arrive at event repository 105 in different time orders to which they occurred. To prevent premature processing of later events before prior occurring events arrive, event repository 105 marshals incoming events for 30 s in a jitter buffer so as to record each event's time order with respect to other received events. Finally, in step 167, event repository 105 calculates the mean approval of a item or category of items, i, from the stored events 105 according to the formula:

$${\hat{D}}_{i} = \frac{1}{E} {\sum }_{e = 1}^{E} {D}_{i , e} \qquad ( 1 )$$

where D_{i,e} is the approval expressed for the eth event of a total E events across all conversations in a given time period. FIG. 17 shows a report 170 generated according to the steps of FIG. 16 where approval is reported for exemplary item “Roomi High Heel Shoes” 171 over a time period 172. Overall approval according to formula (1) is listed 173 with the count E (“Volume”) 174. Approvals 175 are calculated for each PQ events 176, display ranked by size and broken down by A responses 177 to each Q also ranked by size. This allows the third party to determine both the relative importance of a question in relation to an item according to the frequency with which its PQ event is posted and how attitudes to the question are broken down by frequency and approval.

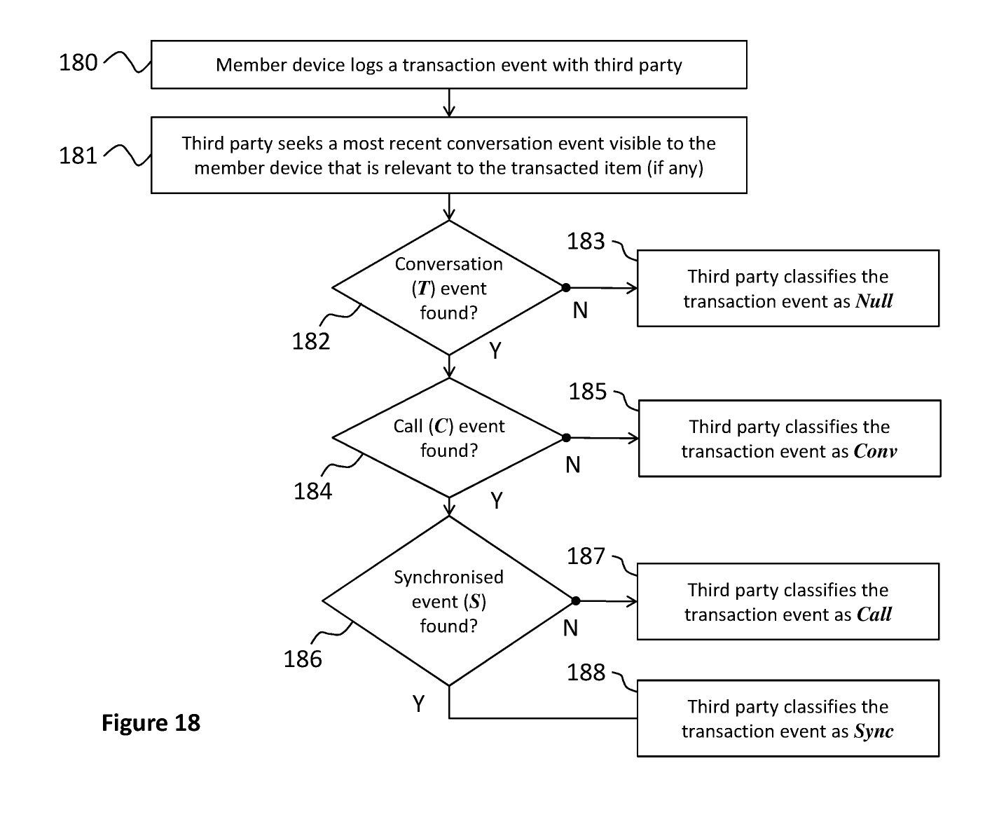

The efficacy of the system of the invention is measured by comparing performance indicators such as conversion rate and return rate determined for transactions that result from use of the system with indicators for transactions when the system is not used (Null transactions). In the embodiment described classification is according to whether transactions occur within a cooling off period (typically 24 hours) of a relevant (1) conversation event (Conv class) or (2) call event (Call class) or (3) a synchronised session event (Sync class), or (4) none of these (Null class). FIG. 18 shows the steps whereby third party and classifies transaction events. A member device logs a retail (R) event to event repository 105 (step 180). Event repository 105 searches for the most recent conversation event prior to the transaction that is visible to the user of the member device for the item related to the transaction event (step 181), for example a question posted subsequent to a viewing (RV) or posting (PI) event for the item. In the embodiment described, an event is determined to be visible to a user of a member device that logged a transaction if it occurred within 5 minutes of specific event types that confirm conversation visibility such as TS. If a conversation event is not found (step 182), the transaction is classified Null to indicate that the user of the member device was not involved in a conversation subsequent to viewing the item and prior to the transaction (step 183). If a conversation event was found at step 182 then a search is applied (step 184) for call events to determine whether the transacting device had been in a call within the conversation prior to the transaction event. The transaction is classified Conv if not in call (step 185) otherwise, if the event type is SL, SF or ST (step 186) the transaction is classified Sync (step 187). Otherwise the transaction is classified as “non-synchronised” (step 188). To those skilled in the art of data processing it is obvious that seeking event records from a database such as event repository 105 that meet the aforesaid criteria is straightforward to achieve using database server scripting languages such as PHP or SQL.

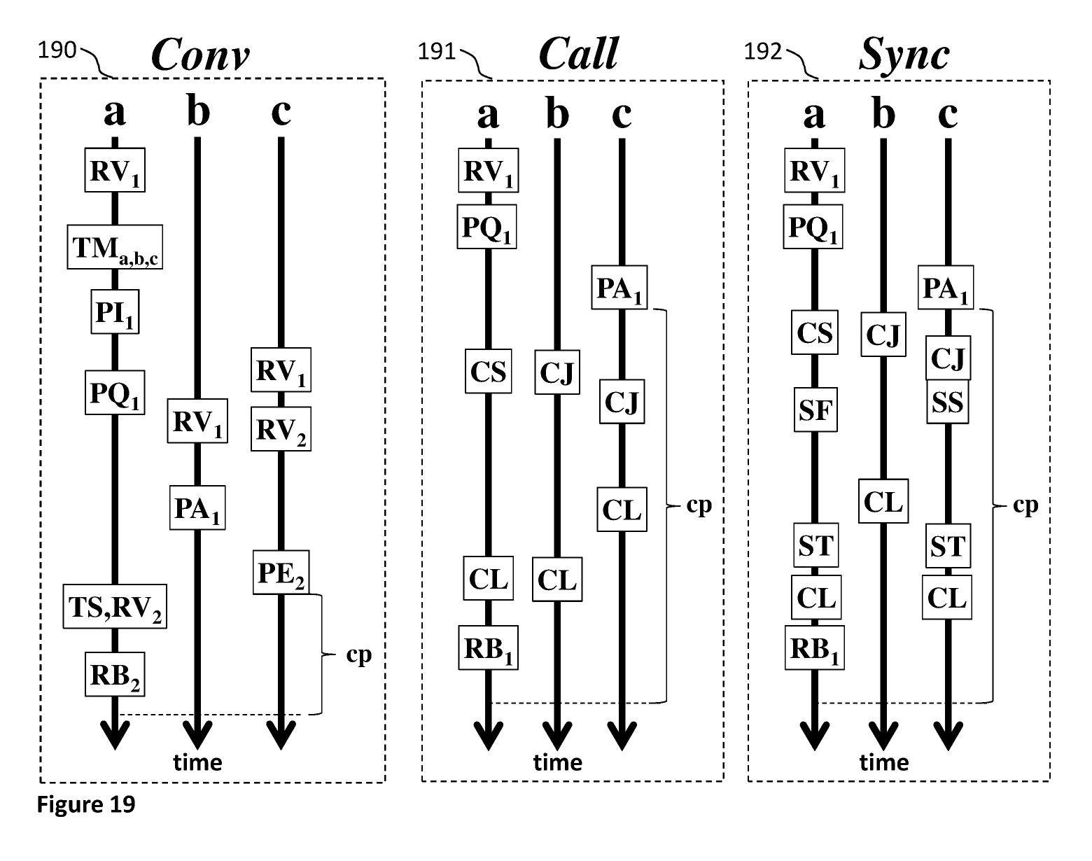

FIG. 19 shows exemplary cases for the transaction classifications and are described as follows. Event codes with subscript item identity are plotted on vertical time axes for member devices according to the times when they are logged into event repository 105. A Conv transaction occurs within a cooling-off period, cp, of a post event logged by another member of the same conversation for the same item whose content is displayed by the transacting device. 190 shows an event, RB₂, logged for an exemplary Conv transaction executed by device a after seeing a post about item 1 from another member of the conversation. Conv transactions are promoted to become Call transactions if the transacting device started or joined a call in the same conversation prior to the transaction. 191 shows an exemplary Call transaction, RB₁, in a conversation after member device a viewed item 1, posted a question and then started a call to discuss a posted answer. Call transactions are promoted to become Sync transactions if the transacting device started or joined a live session in the same call prior to the transaction. 192 shows an exemplary Sync transaction, RB₁, in a conversation after member device a viewed a post about item 1 and then followed in a live session within the same call.

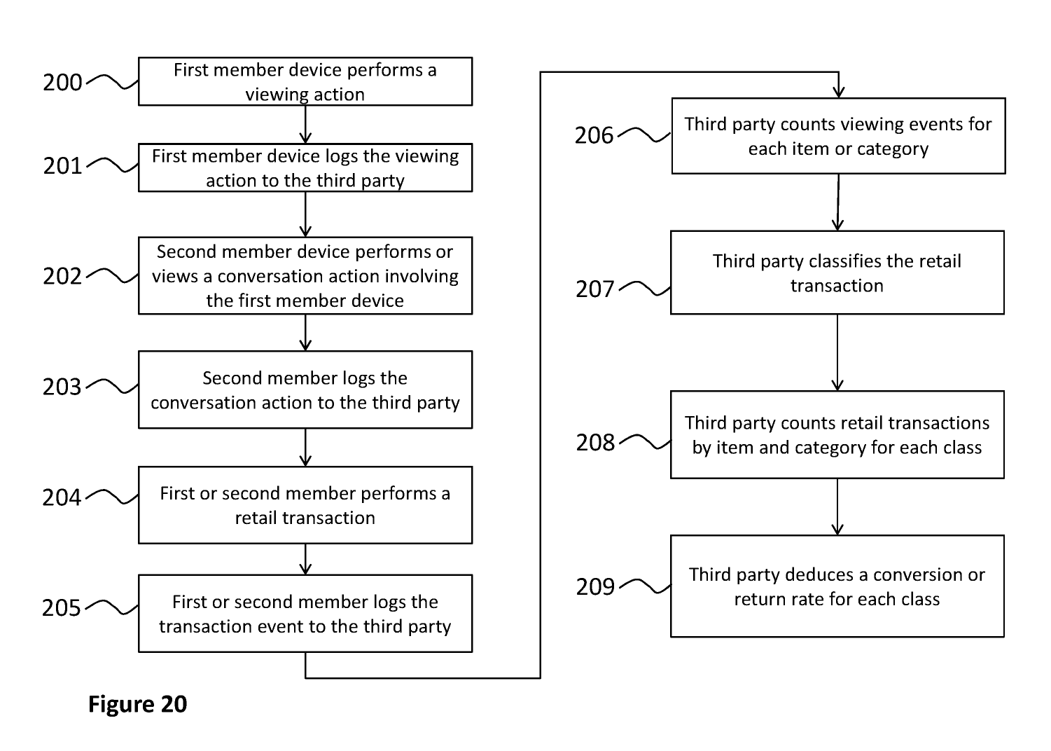

FIG. 20 shows the process to quantify the extents to which the classes of conversation contribute to the purchase or return of an item or category of items by deducing whether a conversation occurred for each transaction event. A first member device performs a post PI action for an item (step 200) and logs the equivalent event to event repository 105 (step 201). A second or subsequent member device performs or views a conversation action common to both devices such as, for example, exchanging a post between the two devices or one device leading the other device (step 202). The second or subsequent device logs the conversation action as an event with repository 105 (step 203). One of the member devices performs a retail action (step 204) and logs its event to repository 105 (step 205). Repository 105 counts the number of viewing events Nᵢ^{V} that occurred over a time period for the item or category of items, i (step 206). Event repository 105 assigns a conversation class C to the retail event at step 204 according to class. Repository 105 increments a counter Nᵢ^{T,C} for the number of transactions in C, where T is a transaction RB or RX event (step 208). At the end of the time period, repository 105 calculates rates for each combination of item/category, i, and conversation class, C. The results for a time period are presented in area 178 (step 209) where “conversion rate” is the number of buy (RB) events divided by the number (“volume”) of view (RV) events as follows:

Nᵢ^{B,C}/Nᵢ^{V,C} (2)

where “return rate” is the number of return (RX) events divided by the number (“volume”) of buy (RB) events as follows:

Nᵢ^{X,C}/Nᵢ^{B,C} (3)

The invention can be implemented as a computer program item, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be deployed to be executed on one computer or on multiple computers at one site or distributed across multiple sites and interconnected by a communication network.

The described embodiment locates repositories 103, 104 and 105 in one physical platform 102, and co-locates message broker and WebRTC processes on platform 106. Alternatively 102 and 106 may be subdivided, co-located and/or distributed across a plurality of communicatively coupled platforms in any combination.

Method steps of the invention can be performed by one or more programmable processors executing a computer program to perform functions of the invention by operating on input data and generating output. Method steps can also be performed by special purpose logic circuitry, e.g., an FPGA (field programmable gate array) or an ASIC (application-specific integrated circuit) or other customised circuitry. Processors suitable for the execution of a computer program include CPUs and microprocessors, and any one or more processors. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g. EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a device having a screen, e.g., a CRT (cathode ray tube), plasma, LED (light emitting diode) or LCD (liquid crystal display) monitor, for displaying information to the user and an input device, e.g., a keyboard, touch screen, a mouse, a trackball, and the like by which the user can provide input to the computer. Other kinds of devices can be used, for example, feedback provided to the user can be any form of sensory feedback, e.g., visual feedback, auditory feedback, or tactile feedback; and input from the user can be received in any form, including acoustic, speech, or tactile input.

A skilled person will appreciate that variations of the order of the steps, processes and disclosed arrangements are possible. Accordingly the above description of the specific embodiment is made by way of example only and not for the purpose of limitation. A reference to a singular entity may mean also a reference to a plurality of the entity, and a reference to a plurality of entities may mean also a reference to a single of the entities. It will be clear to the skilled person that minor modifications may be made without significant changes to the operation described.

1. A communication device for enabling a conversation with at least one other device, the conversation relating to an item; the communication device being adapted to:
present a plurality of user selectable questions relating to the item;
receive a signal indicative of user selection of one of the user selectable questions and
send the selected question to the at least one other device as part of the conversation exchange.

2. A device as claimed in claim 1 where the communication device is adapted to present the item as a subject of the conversation.

3. A device as claimed in claim 1 where the conversation comprises text.

4. A device as claimed in claim 1 where the conversation comprises speech.

5. A device as claimed in claim 1 adapted to store the user selectable questions for presenting to the user in response to a user request.

6. A device as claimed in claim 1 or claim 2 adapted to present a user selectable cell that when selected causes the user selectable questions to be presented to the user.

7. A device as claimed in any of the preceding claims adapted to present a plurality of user selectable answers to relating to an item; receive a signal indicative of user selection of one of the user selectable answers and send the selected answer to the at least one other device.

8. A device as claimed in any of the preceding claims adapted to send a request to a remote device, such as an application server, for information to generate the user selectable questions.

9. A device as claimed in claim 7 adapted automatically to send the request to the remote device in response to selection of item information.

10. A device as claimed in any of the preceding claims adapted to present the user selectable questions or answers in an order that is a function of a predetermined priority rating.

11. A device as claimed in any of claims 1 to 8 adapted to present the user selectable questions or answers in a random order.

12. A device as claimed in any of claims 1 to 8 adapted to receive a signal from a remote device indicative of an order of presentation of the questions and/or answers, and present the questions and/or answers in the indicated order.

13. A device as claimed in any of the preceding claims adapted to present alternately a conversation and content on detection of a gesture.

14. A device as claimed in claim 12 where the gesture is a physical movement of the device or selection of a cell.

15. A device as claimed in any of the preceding claims adapted to select an item automatically in synchronisation with selection of the item by one or a plurality of the other devices of the conversation.

16. A device as claimed in any of the preceding claims adapted to present conversation messages relating to a given item on screen as a group separate from conversation messages relating to a different item.

17. A device as claimed in any of the preceding claims wherein the process of receiving and displaying the questions and answers is implemented as a preloaded native application.

18. A device as claimed in any of claims 1 to 15 wherein the process of receiving and displaying the questions and answers is implemented as web browser executable code such as JavaScript.

19. A system adapted to receive from a plurality of user devices signals indicative of selection of one or more predetermined user selectable questions or answers to questions relating to an item; use the signals to determine an order for presentation of the user selectable item questions or answers and send a signal to each user device to cause the user device to present the questions or answers in the determined order.

20. A system for monitoring the use of predetermined questions and predetermined answers related to one or more items within one or more text conversations between two or more communication devices, the system being adapted to receive from a plurality of user devices events corresponding to posts within the text conversation of the predetermined questions relating to an item or category of items for all conversations between the user devices within a time period; count the number of posts for each of the questions; receive from a plurality of user devices events corresponding to posts of the predetermined answers; and count the answers posted to each of the questions.

21. A system as claimed in claim 19 adapted to send a signal to cause the two or more communication devices to present the questions and answers in a ranked order.

22. A communication device adapted to enable a conversation with at least one other device, for example by using text messages; determine messages in the conversation relating to an item; and present conversation messages relating to the item on screen as a group.

23. A device as claimed in claim 21 adapted to present the determined group of messages in an area that does not overlap with a message relating to another item.

24. A device as claimed in claim 21 or claim 22 adapted to display a group in an open state responsive to selection of the group in a closed state.

25. A device as claimed in claim 23 adapted to display item details responsive to the selection.

26. A device as claimed in claims 21 to 24 adapted to present at least one user selectable item cell that when selected causes all conversation exchanges relating to the corresponding item to be presented on screen as a group.

27. A device as claimed in any of claim 21 to claim 25 adapted to present the conversation according to a changed representation on selection of at least one user selectable cell.

28. A communication device adapted to enable a text conversation with at least one other device; determine conversation exchanges relating to a selected item, and use the content of the conversation or a message relating to the content of the conversation to determine an approval for the item.

29. A communication device as claimed in claim 27 where the message comprises a rating, fixed answer, text or emoticon.

30. A communication device as claimed in claimed in claim 28 where the device calculates a degree of approval according to the degree of the rating.

31. A communication device as claimed in claimed in claim 28 where a third party pre-assigns the degree of approval to a fixed answer or emoticon.

32. A communication device as claimed in any of claims 27 to 30 adapted to send information relating to the determined approval to a remote system for storage and analysis.

33. A communication device as claimed in any of claims 27 to 31 adapted to send the information in response to detection by the device of user selection of another item.

34. A communication device as claimed in any of claims 27 to 32 adapted to assign an approval for each individual conversation exchange relating to the item and use the individual approvals to determine a single overall approval.

35. A communication device as claimed in claim 33 adapted to combine individual approvals to give the single overall approval.

36. A communication device as claimed in any of claims 27 to 34 wherein approval is represented by a number.

37. A communication device as claimed in claim 35 adapted to combine individual approvals by summing or multiplying the individual approvals.

38. A communication device as claimed in any of claims 27 to 36 adapted to determine an approval using the content of the conversation by identifying predetermined words in the conversation indicative of a sense of approval.

39. A communication device as claimed in claim 37 that includes a dictionary of key words that convey a sense of approval.

40. A communication device as claimed in claim 38, wherein each key word has a numerical value according to its degree of approval.

41. A communication device adapted to enable a text conversation with at least one other communication device; identify within the text conversation selection of an item; display the item image and share the item image with the at least one other device.

42. A system for facilitating interactive chat between multiple communication devices relating to an item, the system being adapted to receive signals from the devices relating to actions performed by the devices, each signal comprising an identity of a type of action and an identity of one of the devices; assign degrees of approval to actions which comprise posted messages; sum the degrees for messages that relate to the item and a period of time.

43. A system as claimed in claim 41 where the message is fixed, a text, comprises an emoticon or a rating;

44. A system as claimed in claim 41 or claim 42 where the degrees are aggregated by a value of an elicitation message that precedes the actions.

45. A system adapted to receive from a plurality of user devices signals indicative of selection of one or more predetermined user selectable questions or answers to questions relating to an item; use the signals to determine an order for presentation of the user selectable item questions or answers and send a signal to each user device to cause the user device to present the questions or answers in the determined order.
